(19) United States
(12) Patent Application Publication
(10) Pub. No.: US 2007/0248219 A1
(43) Pub. Date: Oct. 25, 2007

(54) System and Method for Wirelessly Actuating a Moveable Structure

(76) Inventors: W. Dale Foster, Dallas, TX (US); E. Noel Gouldin, Plano, TX (US); Stuart W. Stevenson, Palno, TX (US)

Correspondence Address: SCOTT T. GRIGGS, 901 MAIN STREET, SUITE 6300, DALLAS, TX, 75202, US

(21) Appl. No.: 11/690,779

(22) Filed: Mar. 23, 2007

Related U.S. Application Data
(60) Provisional application No. 60/743,710, filed on Mar. 23, 2006.

(51) Int. Cl. H04M 11/00

(52) U.S. Cl. 379/102.06

(57) ABSTRACT

A system and method for wirelessly actuating a moveable structure are disclosed. In one embodiment, a cellular device is utilized to send a command signal to a server, which, in turn verifies the command signal and, upon verification, transmits a control signal over a cellular network. The control signal is received by a local access device that is electromechanically coupled to a control unit for actuating the moveable structure from a first position to a second position in response to receiving the control signal.

### PRIORITY STATEMENT & CROSS-REFERENCE TO RELATED APPLICATIONS

This application claims priority from co-pending U.S. Patent Application No. 60/743,710, entitled “System and Method for Actuating a Moveable Structure” and filed on Mar. 23, 2006, in the names of W. Dale Foster, E. Noel Gouldin, Jr., and Stuart W. Stevenson; which is hereby incorporated by reference for all purposes.

### TECHNICAL FIELD OF THE INVENTION

This invention relates, in general, to remote control functions and, in particular, to a system and method for wirelessly actuating a moveable structure to gain access to a property by an access barrier such as a gate.

### BACKGROUND OF THE INVENTION

Property owners and, in particular, rural property owners occasionally need to allow an individual including a family member, friend, or repair personal, for example, access to a property protected by an access barrier such as a gate. Granting access to the property is a challenge when no one is home to receive the individual or available to meet the individual at the property. Existing solutions that provide alternatives to leaving the property unsecured include providing the individual with a key, remote control, or access code. Each of these existing approaches compromises security and/or inconveniences the property owner in some fashion. Additionally, land phone lines, trenching, mounting poles, card readers, and phone based exchange systems may be required. Accordingly, a need exists for a system and a method for safely granting individuals access to a gated property when the property owners are not home or available.

### SUMMARY OF THE INVENTION

A system and method are disclosed for wirelessly actuating a moveable structure or an access barrier which may be a gate, a door, or other structure, for example, that includes at least one panel which is swung, drawn, raised, or lowered to partially or completely close an entrance or passageway. In one embodiment, a server having a computerized Interactive Voice Response (IVR) system, which is operable to receive telephone calls, wirelessly communicates with a local access device associated with the access barrier. The local access device may include a wireless modem and an interface for communicating with a control unit, such as a gate control box that actuates the moveable structure.

The server may employ a Global System for Mobile Communications (GSM)-based protocol, such as General Packet Radio Service (GPRS), or a Short Message Service (SMS) protocol or standard, for example, to communicate with the control unit over a wireless telecommunications network or cellular network. It should be appreciated, however, that any cellular or mobile protocol may be utilized. In one operational embodiment, a user calls the server with a land line telephone or cellular telephone. The IVR system answers the call and, in response to receiving a unique access code, the server sends a message to the local access device instructing the local access device to actuate the access barrier by way of a control signal to the control unit. The property owner may use the Internet to maintain the system and local access device and specify the unique access codes. In another embodiment, the systems and methods described herein, including the management server and the local access device, are utilized to effect a transition in a locking mechanism from a first state to a second state in response to receiving a control signal. This embodiment is substantially similar to the embodiment for actuating a moveable structure, however, the local access device is coupled to a control unit for a locking mechanism as opposed to a control unit for a moveable structure.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1A is a schematic diagram of one embodiment of a system for wirelessly actuating a moveable structure being employed in a networked environment with multiple properties each having a moveable structure;

FIG. 1B is a schematic diagram depicting the system for wirelessly actuating a moveable structure presented in FIG. 1A being utilized with one particular property.

FIG. 2 is a schematic block diagram depicting one embodiment of a management server;

FIG. 3 is a schematic block diagram depicting one embodiment of a local access device;

FIG. 4 is a schematic block diagram depicting another embodiment of a local access device;

FIG. 5 is a flow chart depicting one embodiment of a method for wirelessly actuating a moveable structure;

FIG. 6 is a flow chart depicting another embodiment of a method for wirelessly actuating a moveable structure;

FIG. 7 is a flow chart depicting a further embodiment of a method for wirelessly actuating a moveable structure; and

FIG. 8 is a flow chart depicting one embodiment of a method for wirelessly effecting the state of a locking mechanism.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

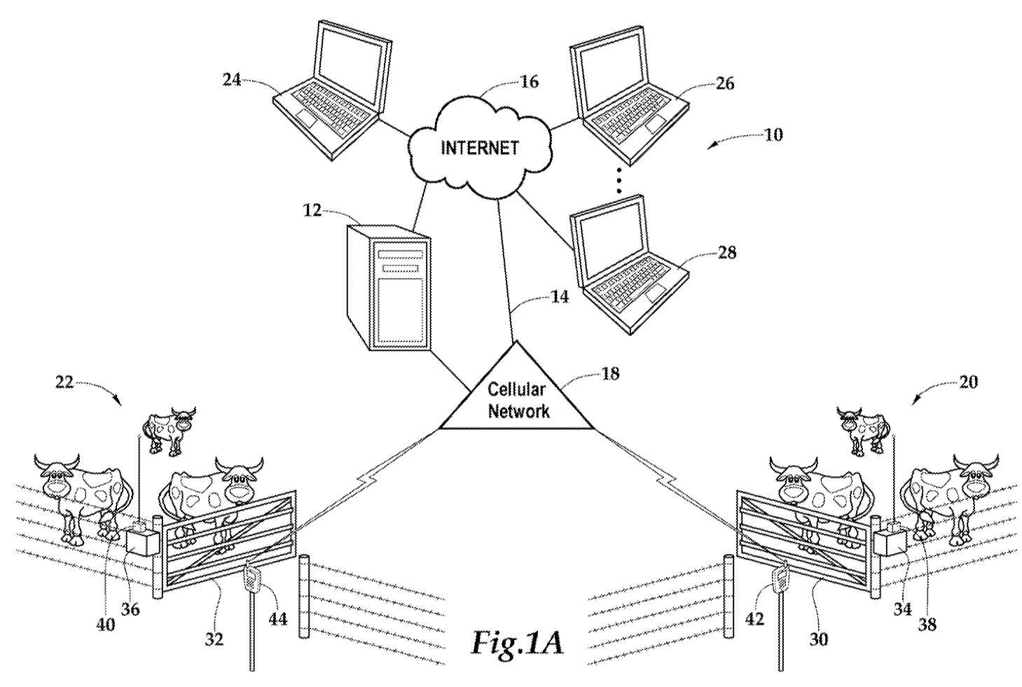

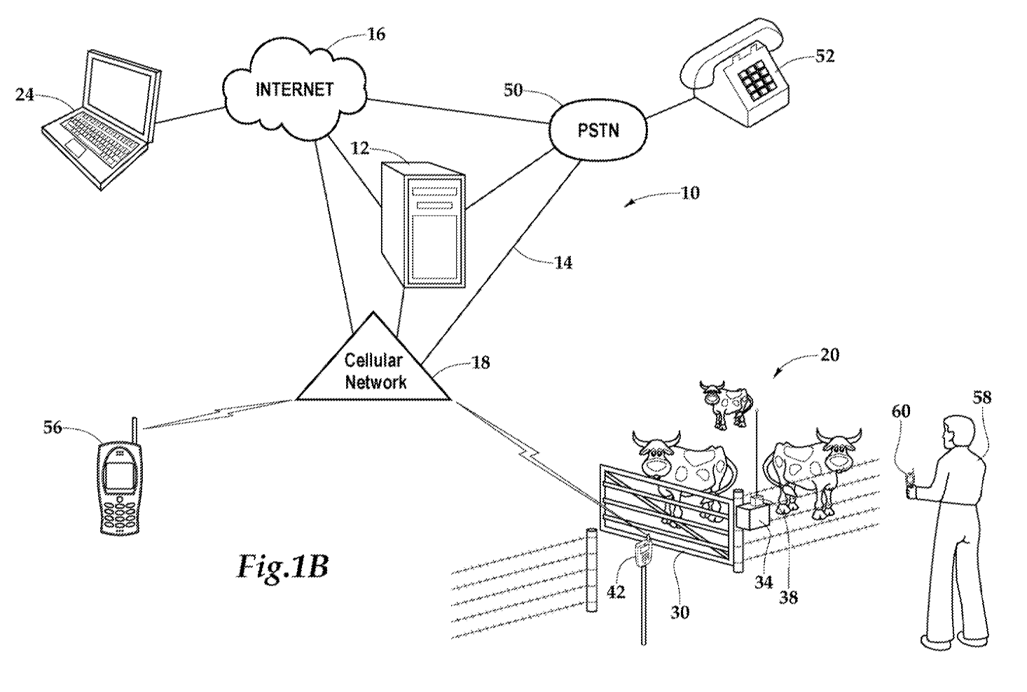

Referring initially to FIG. 1A, therein is depicted a system for wirelessly actuating a moveable structure that is schematically illustrated and generally designated 10. The system 10 includes a management server 12, which may be referred to as a server 12, being employed in a networked environment 14, as represented by Internet 16 and cellular network 18, with multiple properties 20, 22. Multiple computers 24, 26, 28 are connected to the Internet 16 and may be utilized by system administrators or users, as explained in further detail hereinbelow, to access and maintain the system.

Each property 20, 22 respectively includes a moveable structure 30, 32 and control units 34, 36 associated therewith for actuating the moveable structures 30, 32. Local access devices 38, 40 are respectively associated with moveable structures 30, 32 and control units 34, 36 to relay control signals for actuating the moveable structures 30, 32 from the management server 12 to the control units 34, 36. In operation, as will be explained in further detail in FIG. 1B, the management server 12 in combination with local access devices 38, 40 permits property owners and users to actuate the moveable structures via any device having access to the Internet 16, the cellular network 18, or a Publically Switched Telephone Network (PSTN), for example. Moreover, in one embodiment, call boxes 42, 44 are respectively provided at properties 20, 22 to enable individuals without access to a device, such as a computer, cell phone or a land line telephone, at the property to actuate and control the moveable structure. Accordingly, the systems and methods presented herein provide a completely self-contained solution for actuating a moveable structure in any place having cellular network coverage. Land phone lines, trenching, mounting poles, card readers, and phone based exchange systems are not required for use of the present system as the system utilizes a cellular network and remote server to maintain and actuate the moveable structure. Additionally, the systems and methods presented herein provides security without inconveniences to the property owner.

Although the properties 20, 22 are depicted as ranches, it should be appreciated that each property 20, 22 may be any other type of property having any type of barrier or structure. Further, each moveable structure may include any structure having one panel which completes a motion in order to at least partially close an entrance selected. The motion may be being swung, being drawn, being raised, or being lowered, for example. Accordingly, by way of example, a property and moveable structure may include a gate at a ranch, a garage door to a townhouse, or a gate to an estate or home.

Further, the teachings presented herein, as will be illustrated in further detail hereinbelow, may be utilized with locking mechanisms that may or may not be associated with moveable structures. Locking mechanisms include mechanical devices, such as locks and keys, electromechanical devices such as access card systems, magnetic locks, and solenoid bolts, for example. In this implementation, the server and local access device presented herein effect the state of locking mechanism, by for example, transitioning the state from opened to closed. This embodiment is substantially similar to the embodiment for actuating a moveable structure, however, the local access device is coupled to a control unit for a locking mechanism as opposed to a control unit for a moveable structure.

FIG. 1B depicts the system 10 for wirelessly actuating the moveable structure 30 presented in FIG. 1A being utilized with the property 20. As illustrated, the networked environment includes a PSTN 50 that connects a land line 52 to the management server 12. It should be appreciated that although network supply service PSTN 50 is depicted as the PSTN, other network supply services are within the teachings presented herein. By way of example, a Plain Old Telephone Service (POTS), highspeed cable-based system, or other phone system providing local and long distance interconnectivity may be utilized as well. A cellular device 56 is in communication with the cellular network 18. A cellular device caller 58 having a cellular device 60 disposed in wireless communication with the cellular network 18 is at the property 20. The cellular devices 56, 60 may comprise cellular telephones, personal digital assistants (PDAs) or other electronic communication devices, for example. It should be appreciated that the network 14 may also be a hybrid of the indicated Internet 16, cellular network 18, and PSTN 50.

As previously alluded to, the cellular device caller 58 utilizes the cellular device 60 disposed in wireless communication with the cellular network 18 to actuate the access barrier 30. The cellular device 60 accepts a command signal, which may include an access code, and transmits the accepted command signal over the cellular network 18. The management server 12, in response to receiving the command signal, verifies the command signal and, upon verification, transmits a control signal, which may identical or different from the command signal, over the cellular network 18.

The control unit 34 associated with the moveable structure 30 actuates the moveable structure 30 from a first position to a second position in response to receiving a control signal. The local access device 38, which is electromechanically coupled to the control unit 34 and disposed in wireless communication with the cellular network 18, upon receiving the control signal from the management server 12, forwards the control signal to the control unit 34. The control signal received by the local access device and sent to the control unit may be the same control signal or a modified control signal. Additionally, depending on the command, such as hold open (e.g., open for 5 minutes, then close), a control signal may comprise more than one signal sent to the control unit.

The operation of the system 10 will be now presented in more detail with respect to the movable structure 30 being actuated via a computer 24, the land line 52, a cellular device 56, the individual 58 on the property 20 using the cellular device 60 (this case being presented in the previous paragraph and presented again in further detail), and the individual using the call box 42 as presented and summarized in the following table, Table I: Exemplary Operational Modes.

TABLE I
Exemplary Operational Modes

| Operational Mode | Operation |
|---|---|
| 1 | Onsite Actuation via the Cellular |
| | Network 18 |
| 2 | Actuation via the PSTN 50 |
| 3 | Actuation via the Cellular Network 18 |
| 4 | Actuation via the Internet 16 |
| 5 | Onsite Actuation via the Call Box 42 |
| 6 | Use of ANI |

### It should be appreciated, however, that other modes of operation are within the teachings of the present invention and these exemplary modes of operation are non-limiting examples.

With respect to Operational Mode 1, an individual 58 approaches the property and desires to open the moveable structure 30, which is a gate to ranching or hunting property, for example. The individual 58 has been provided with a service number, such as an 800 or 888 number, and a gate number and gate access code. The individual 58 utilizes the cellular network 18 to call the service number which connects the cell phone 60 of the individual 58 with the management server 12. At this time, the individual 58 enters a command signal, such as the appropriate gate number, gate access code, and command, which is transmitted and verified by the management server 12. In response thereto, the management server 12 sends the local access device 38 via the cellular network 18 a control signal with instructions to open the moveable structure 30. The local access device 38 relays these instructions to the control unit 34, which opens the moveable structure 30 for the individual.

With respect to Operational Mode 2, a home owner may receive a call from a friend requesting that the moveable structure 30 to property 20 be opened. The home owner may then call the service number with land line 52 and connect to the management server 12 by way of PSTN 50. Similar to the previous example, upon entering a command signal, the management server 12 sends a control signal by way of the cellular network 18 to the local access device 38 which in turn effects the actuation of the moveable structure 30.

With respect to Operational Mode 3, similar to Operational Mode 2, a home owner may receive a call from a friend requesting that the moveable structure 30 to property 20 be opened. The home owner may then call the service number with cell phone 56 and connect to the management server 12 by way of cellular network 18. The operation of this embodiment is substantially similar to the Operational Mode 2 once the management server 12 receives the command signal and sends the control signal to the local access device 34.

With respect to Operational Mode 4, the actuation is achieved via computer 24 and Internet 16. In this operational mode, a user logs into a website with a user name and password and then selects the gate and desired actuation. Upon receiving this information via the Internet 16, the management server 12 sends a control signal via the cellular network 18 to the local access device 38 to achieve actuation of the moveable structure 30 as previously discussed. With respect to Operational Mode 5, onsite actuation of the moveable structure is achieved through a call box 42 which is disposed in wireless communication with the management server 12 via the cellular network 18. Once a code is entered or a button is pushed, the management server 12 relays audio communication between the call box 42 and a predetermined telephone, such as telephone 52 or cellular telephone 56. In one implementation, the predetermined telephone belongs to the owner of the property 20. While the phone call is connected and the parties are given the opportunity to talk, the owner has the opportunity to enter a command code to actuate the moveable structure. Once the command code is entered and received by the management server 12, as previously discussed, a control signal is generated and transmitted to the local access device 38 via the cellular network 18.

Operational Mode 6 may be utilized with the previously discussed modes and, in particular, with Operational Modes 1 through 3. In this mode, the server utilizes Automatic Number Identification (ANI) to capture the telephone number associated with the telephone placing the call. If the telephone number is in the database of the server, then the captured telephone number, if this feature is enabled by the owner, may be used to identify the moveable structure. This identification technique saves the caller from entering the gate number each time a call is placed. This feature is especially useful for a call that uses a particular phone to frequently access one moveable structure or locking mechanism.

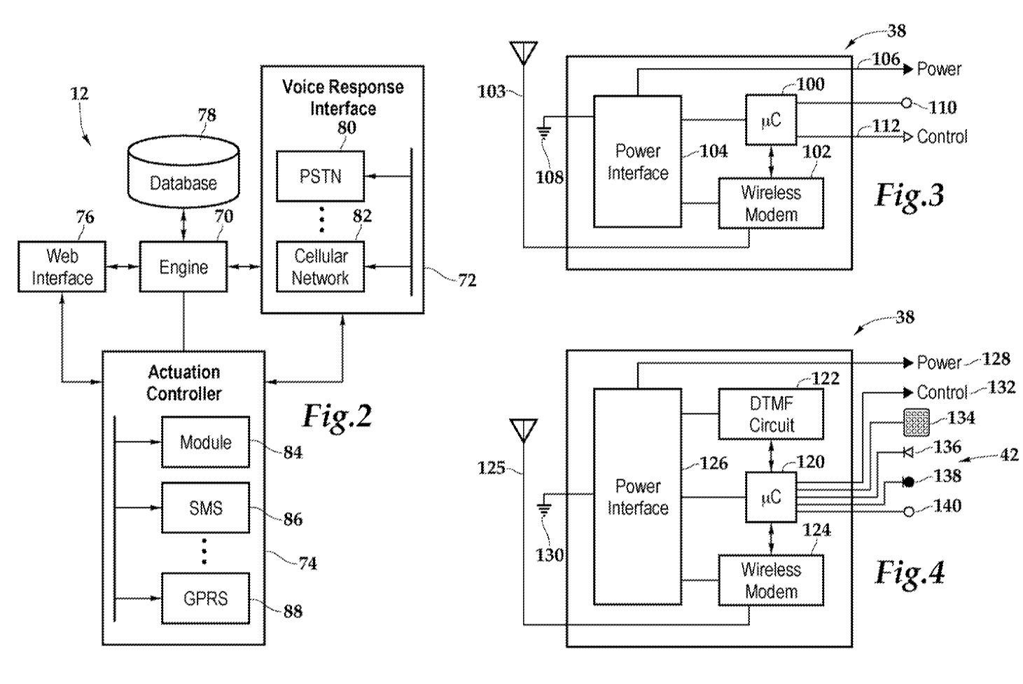

FIG. 2 depicts one embodiment of a management server 12, which includes an engine 70 and connected thereto a voice response interface 72, an actuation controller 84, a web interface 76, and a database 78. The engine 70 includes the software, hardware, and firmware necessary to drive the functionality of the management server 12, which includes moveable structure actuation and management services to users via the Internet 16, cellular network 18, and PSTN 50. The voice response interface 72 is a computerized subsystem of the management server 12 that allows a person, such as a telephone caller or cell phone user, to select options from a voice menu and otherwise interact with the computer phone system.

In one implementation, voice response interface includes an Interactive Voice Response (IVR) system that plays a pre-recorded voice prompt and the caller presses a number on a telephone keypad to select or designate an option. For example, “please enter the gate number followed by the pound sign” or “press 1 for open and immediately close, press 2 for open and keep open”. In other implementations, the voice response interface may recognize the caller's simple spoken answer such as “yes”, “no”, or a number as a valid response to the voice prompt. The voice response interface may use Dual Tone Multi-Frequency (DTMF) signals (generated by interaction with the telephone keypad), natural language speech recognition, and other IVR technology to interpret the caller's response to prompts. To interface with the cellular network 18 and the PSTN 50, the voice response interface includes a PSTN module 80 and a cellular network module 82. It should be appreciated that although one particular architecture is presented for the management server, the management server may comprise any combination of hardware, software, and firmware.

As alluded to the previous paragraphs, in actuating a moveable structure or effecting the state of a locking mechanism, a user may be presented with several options. A portion of the access options are presented and summarized in the following table, Table II: Access Options.

TABLE II
Access Options

| Actuation Mode | Operation |
|---|---|
| A | Open |
| B | Close |
| C | Delay Open (e.g., in five minutes) |
| D | Delay Close (e.g., in five minutes) |
| E | Open and Hold (e.g., open for 5 |
| | minutes, then close) |
| F | Turn Access Options “Off” |
| G | Turn Access Options “On” |
| H | Modify Access Number |
| I | Hold Open |
| J | Delay Close |

It should be appreciated, however, that other access options are within the teachings of the present invention and these exemplary modes of actuation are non-limiting examples that apply to a telephonic interface as well as a computer or web interface.

The actuation controller 74 is a computerized subsystem of the management server 12 that controls the signaling sent to the local access devices. In order to interface with the local access devices, the actuation controller 74 includes protocol modules, such as protocol module 84, SMS module 86 and GPRS module 88. It should be appreciated that the management server 12 including the actuation controller 84 may utilize any type of cellular protocol to communicate with the local access devices. As depicted, GPRS and SMS are presented. GPRS is used as a data services upgrade to any GSM network. It allows GSM networks to be truly compatible with the Internet by employing a packet-mode technique to transfer bursty traffic in an efficient manner. SMS is used to transfer text messages over mobile networks between a GMS Public Land Mobile Network (PLMN) mobile station and a short message entity via a service center.

The web interface 76 accepts input from users and provides output to users by generating webpages which are transported via the Internet 16 and viewed by the user using a web browser program on the computer 24, for example. In one implementation, the web interface 76 utilizes a series of menus and websites to provide substantially realtime control and administrative functions related to the moveable structures. By way of example, the web interface 76 may provide account setup, creation of access codes, creation of temporary access codes, creation of access codes having date ranges, reporting on use. Additionally, the web interface 76 may include a unique homepage for each user that specifies the current status of each gate and other related information in an environment having a user-friendly graphical interface. Further, it should be appreciated that the access and control privileges may vary between the users and administrators. The database 78 may comprise a structured collection of records or data which is stored such that the applications and programs embedded in the management server 12 using a query language, such as a Structured Query Language (SQL), can access and consult. For example, the ANI functionality may be enabled by the database 78. Additionally, the access options presented in Table II may also be supported by the database 78. Accordingly, the system presented herein provides property access to family, friends, and service personal using a wireless architecture that leverages cellular protocols.

FIG. 3 depicts one embodiment of a local access device 38 which may interface with a standard or conventional control unit, such as a gate control unit. A microcontroller 100 controls the local access device 38 and provisions the interface with the cellular network. More specifically, the microcontroller 100 contains all the processing, memory, and interfaces needed for supporting the relaying functionalities of the local access device and actuation of moveable structure through the control unit. Two components are connected to the microcontroller; namely, a wireless modem 102 and a power interface 104. The wireless modem 102 uses an antenna 103 to form a wireless access point connecting the local access controller 38 to the management server 12 via the cellular network 18. In one implementation, the wireless modem 102 may be considered a gateway to the control unit 18 that provides for the exchange of data.

The power interface 104 distributes power to the microcontroller 100 and the wireless modem 102. A power connection 106 receives power from the control unit 34 and a ground connection 108 is appropriately grounded. The power interface 104 may be used with both 12 and 24 volt DC systems or AC systems. In one implementation, the power connection 106 is part of a cable that connects to the local access unit 38 by a RJ-12 jack and utilizes standard yellow, red, and black wires to connect to the control unit. In this implementation, power is received from the control unit and control signals are sent to the control unit.

The microcontroller 100 includes a control connection 112 and an indicator 110, such as an LED, which provides a status light (e.g., “On” or “Off”) . In response to the wireless modem 102 receiving a control signal from the management server 12, the signal is relayed to the microcontroller 100 which, in turn, forwards the control signal to the control unit 34 by way of the control connection 112. It should be appreciated that modifications and changes to the architecture of the local access device 38 are within the teachings of the present invention. By way of example, the power interface 112 may be replaced or supplemented with a power source such as a battery or solar power collector. Additionally, by way of further example, components may be combined. The microcontroller 100 and wireless modem 102 may be combined. Moreover, the local access device 38 may be partially or completely integrated with the control unit in particular implementations and OEM offerings.

FIG. 4 depicts another embodiment of a local access device 38 having a call box 42 integrated therewith. It should be appreciated that in embodiments utilizing a call box, the call box may be separate, partially, or completely integrated with the local access device. The architecture of the local access device 38 of FIG. 4 is similar to the architecture of the local access device 38 of FIG. 3. In particular, microcontroller 120, wireless modem 124, antenna 125, power interface 126, power connector 128, ground 130, control connection 132, and indicator 140 are substantially equivalent to their correspondingly named components in FIG. 3.

Further, the wireless modem 124 is enhanced to handle data including voice. A control panel 134, a speaker 136, and a microphone 138 are also included and connected to the microcontroller 120. These components may form the call box 42 that may, in particular implementations, allow for pre-assigned access codes which may be entered directly into the call box 42 to gain entry to the property or premises by actuating a moveable structure or effecting a state transition in a locking mechanism. The control panel 134, speaker 136, and microphone 138 enable a visitor to enter data and send and receive audio. The local access device 38 also includes a DTMF circuit 122 for accepting numbers entered by a user at the control panel 134 and implementing associated signaling over the line in the voice-frequency band to the management server 12, which once receiving this signaling, dials the appropriate number to connect the user with the property owner, for example. It should be understand that whether the local access device 38 is utilized to actuate a moveable structure or effect a state transition in a locking mechanism, the local access device may have the components and architecture described hereinabove.

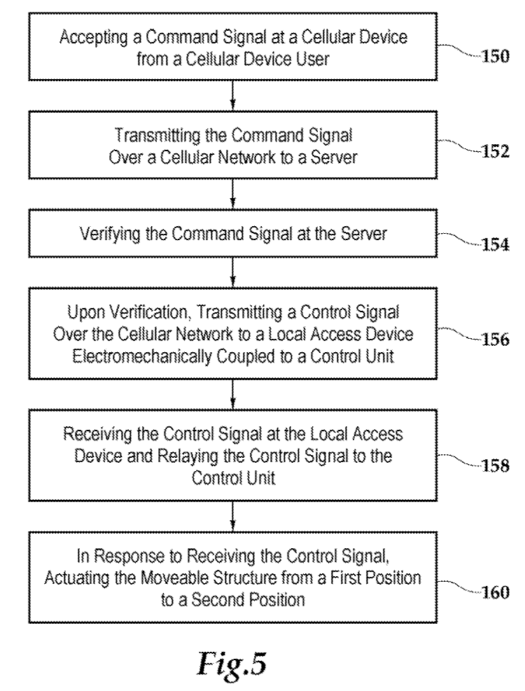

FIG. 5 depicts one embodiment of a method for wirelessly actuating a moveable structure. At block 150, a command signal is accepted at a cellular device disposed in wireless communication with a cellular network. At this time, a cellular device caller may be provided with options from a voice menu to actuate or otherwise command the moveable structure. At block 152, the accepted command signal is transmitted over the cellular network to the server. In one implementation, ANI may be utilized at the server to capture a telephone number associated with the cellular device. With this information, the server may identify the moveable structure based on the captured telephone number. At block 154, the command signal is verified at the server.

Upon verification of the command signal, at block 156, a control signal is transmitted over the cellular network to a local access device electromechanically coupled to a control unit. At block 158, the control signal is received at the local access device and then relayed to the control unit. In response to receiving the control signal at the control unit, at block 160, the moveable structure is actuated from a first position to a second position, which may be, from opened to closed or closed to open, for example.

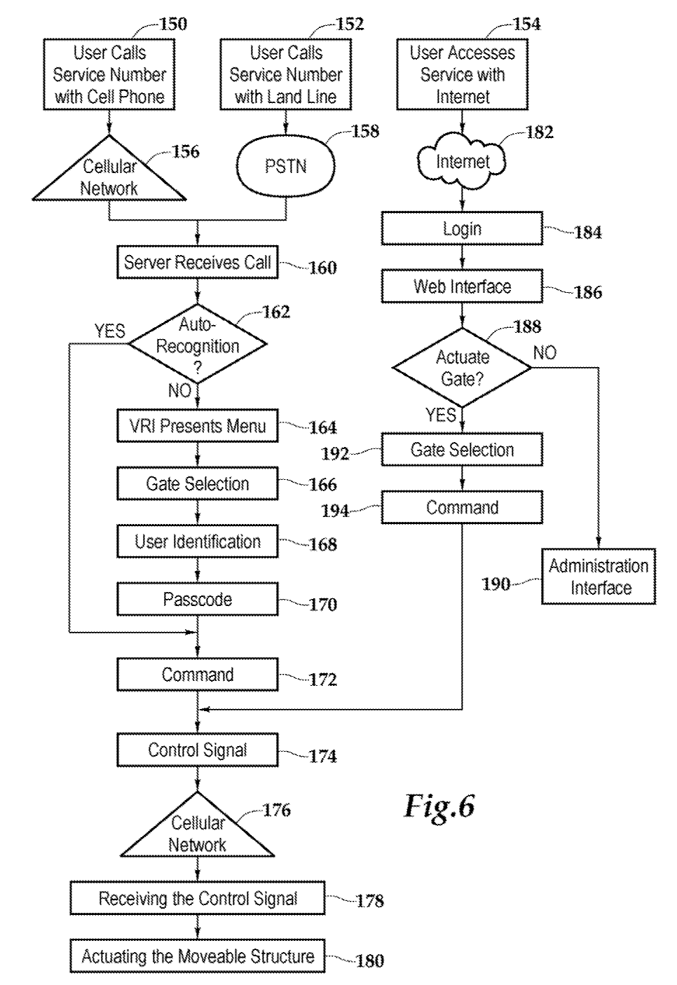

FIG. 6 depicts another embodiment of a method for wirelessly actuating a moveable structure. In this particular embodiment, three methods for a user to actuate a moveable structure are presented; namely by utilizing a cell phone as depicted by block 150, utilizing a telephone as depicted by block 152, and utilizing a website as depicted by block 154. With respect to block 150, a user may call a service number, such as a toll free 800 or 888 number, with a cellular device and actuate the moveable device by way of the cellular network, which is depicted at block as enabling the call at block 156. Similarly, at block 152, a user may call the service number with a land line using the PSTN at block 158.

At block 160, the management server receives the call. In the illustrated methodology, the system is utilizing auto-recognition wherein ANI captures a telephone number associated with the cellular device and the server identifies the moveable structure based on the captured telephone number. If auto-recognition is enabled and the gate is identified then the process advances to block 172. Otherwise, the process advances to block 164. At block 164, a VRI presents the user with a menu of options wherein at block 166, the gate is selected and subsequently at blocks 168 and 170, a user identification and passcode are entered.

At block 172, the command to actuate the moveable structure is inputted. The server generates the control signal as shown at block 174 and transmits the control signal to actuate the gate via the cellular network at block 176. At blocks 178 and 180, the control signal is received from the management server and relayed from the local access device to the control unit in order to actuate the moveable structure.

Returning to block 154, wherein the user accesses the service with the Internet as represented in the following block 182. At block 184, the user logins to the website and interacts with the web interface at block 186. If the user does not want to actuate a gate, then the user, which may be an administrator, advances to the administration interface 190 where the appropriate planning and control menus are presented. If the user does want to actuate a gate, then the process advances to blocks 192 and 194 wherein the gate and command are selected. At this point in the process, the methodology continues to blocks 174 through 180 which as previously discussed culminate in the actuation of the moveable structure at block 180.

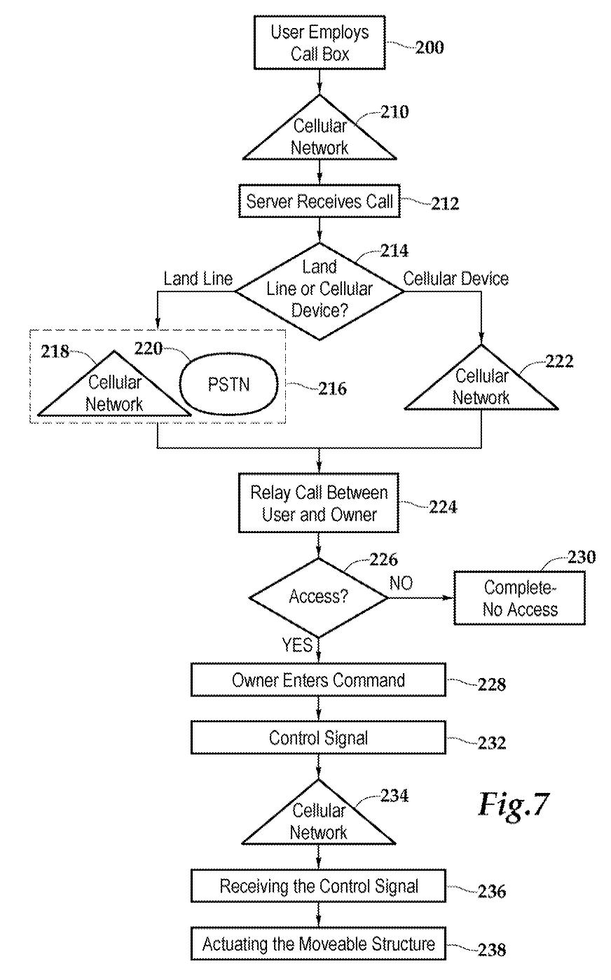

FIG. 7 depicts a further embodiment of a method for wirelessly actuating a moveable structure wherein at block 200 a user employs a call box of the type presented in conjunction with FIG. 4. The user's call is enabled from the call box to the management server by the cellular network as depicted by block 210. As part of enabling the call, the call box accepts an access code. At block 212, the server receives the call at block 214, the server establishes a relay between the call box and a telephone via the cellular network and a Publically Switched Telephone Network, respectively, as depicted by network block 216 which includes the cellular network block 218 and the PSTN block 220. Alternatively, the server may establish a relay between the call box a cellular telephone via the cellular network as depicted by block 222.

The server utilizes the captured access code to identify the telephone, whether a land line or cellular, and associated moveable structure. Typically, the identified telephone will belong to the owner or manager of the moveable structure. It should be understood that to utilize this functionality of connecting a visitor or user with a property owner, who may be remote, the owner or administrator must have provided the management server with the phone number to associate with the particular moveable structure (or locking mechanism). At block 224, the call is relayed between the user and owner or manager. At block 226, if the owner desires to give the user access to the property, then a command is entered at block 228. On the other hand, if the owner does not desire to grant access, then the process is complete at block 230, access is denied, and the moveable structure is not actuated.

Returning to block 232, wherein upon receipt of a command signal from the telephone, a control signal is transmitted over the cellular network to a local access device electromechanically coupled to a control unit as depicted at blocks 234 and 236. At block 238, the control signal is received at the local access device and relayed to the control unit such that the moveable structure is actuated from a first position to a second position. Accordingly, this embodiment provides a voice connection from the call box to the house, office, or cell phone, for example, of the owner and the ability to receive ad hoc visitors that may not have a cell phone, a pre-assigned access code or the phone number of the owner. Moreover, this embodiment may be embellished by providing pre-assigned access codes which may be entered directly into the call box to gain entry to the property or premises by actuating a moveable structure or effecting a state transition in a locking mechanism.

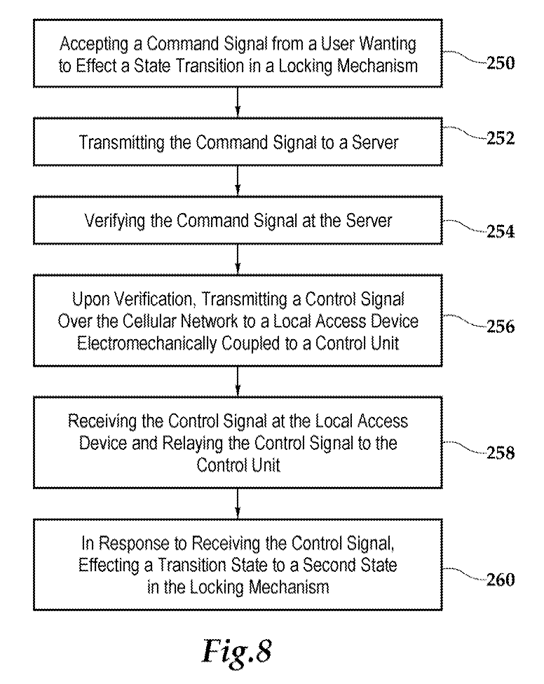

FIG. 8 depicts one embodiment of a method for wirelessly effecting a transition in the state of a locking mechanism, which may include a physical lock, a magnetic lock, or electromechanical locking mechanism such as a solenoid bolt, for example. The physical lock may be a mechanical fastening or release device, such as a deadbolt or pull-back device, which may be used on a door, vehicle, or container in order to restrict access to the enclosed area or property. The property or enclosed area may be vary from a lock box, to locks on trailers or cargo containers, to locks for a ranch. The magnetic lock may be a locking device that consists of an electromagnet and armature plate. By attaching the electromagnet to the door frame and the armature plate to the door, a current passing through the electromagnet attracts the armature plate holding the door shut. The solenoid bolt may be a type of electromechanical locking mechanism which is characterized by the use of a solenoid to throw the bolt. In particular, the solenoid bolt may use a microprocessor to perform voltage regulation or reduce power consumption while providing access control.

At block 250, a command signal is inputted from a user into a cellular device, land line telephone, onsite call box, or via the Internet. At block 252, the accepted command signal is transmitted over the network to the server. The network may be the cellular network, Internet, or PSTN, depending on the device the user employs. Upon verification of the command signal, as depicted by blocks 254 and 256, a control signal is transmitted over the cellular network to a local access device mechanically and/or electromechanically coupled to the control unit. At block 258, the control signal is received at the local access device and then relayed to the control unit. In response to receiving the control signal at the control unit, at block 260, a state change to a second state from a first state is effectuated and the locking device transition is effected from a first state to a second state. By way of example, the locking mechanism may transition from open to closed or closed to open. By way of another example, the locking mechanism may transition from an active magnetic state to an inactive magnetic state. It should be appreciated that this system and method for effecting a locking mechanism may incorporate any of the embodiments discussed hereinabove with respect to actuating a moveable structure.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for wirelessly actuating a moveable structure, the system comprising:
a cellular device disposed in wireless communication with a cellular network, the cellular device for accepting a command signal and transmitting the accepted command signal over the cellular network;
a server, in response to receiving the command signal, for verifying the command signal and, upon verification, transmitting a control signal over the cellular network;
a control unit associated with the moveable structure, the control unit for actuating the moveable structure from a first position to a second position in response to receiving a command signal; and
a local access device electromechanically coupled to the control unit and disposed in wireless communication with the cellular network, the local access device for receiving the control signal from the server and forwarding the control signal to the control unit.

2. The system as recited in claim 1, wherein the cellular device further comprises an electronic communication device for personal communication.

3. The system as recited in claim 1, wherein the moveable structure comprises a structure including one panel which completes a motion in order to at least partially close an entrance selected, the motion selected from the group consisting of being swung, being drawn, being raised, and being lowered.

4. The system as recited in claim 1, the server comprises an Interactive Voice Response (IVR) system which provides a cellular device caller options from a voice menu to command the moveable structure.

5. The system as recited in claim 1, wherein the control unit and the local access device are at least partially integrated.

6. The system as recited in claim 1, wherein the fist position to the second position corresponds to an open position to a closed position.

7. The system as recited in claim 1, wherein the first position to the second position corresponds to a closed position to an open position.

8. The system as recited in claim, wherein the control signal includes instructions selected from the group consisting of open, hold open, delay open, close, and delay close.

9. A method for wirelessly actuating a moveable structure, the method comprising:
accepting a command signal at a cellular device disposed in wireless communication with a cellular network;
transmitting the accepted command signal over the cellular network;
verifying the command signal at a server;
upon verification of the command signal, transmitting a control signal over the cellular network to a local access device electromechanically coupled to a control unit;
receiving the control signal at the local access device and relaying the control signal to the control unit; and
in response to receiving the control signal at the control unit, actuating the moveable structure from a first position to a second position.

10. The method as recited in claim 9, further comprising providing a cellular device caller options from a voice menu to command the moveable structure.

11. The method as recited in claim 9, further comprising:
utilizing Automatic Number Identification at the server to capture a telephone number associated with the cellular device; and
identifying the moveable structure based on the captured telephone number.

12. A system for wirelessly actuating a moveable structure, the system comprising:
means for accepting a command signal at a cellular device disposed in wireless communication with a cellular network;
means for transmitting the accepted command signal over the cellular network;
means for verifying the command signal at a server;
means for transmitting, in response to verification of the command signal, a control signal over the cellular network to a local access device electromechanically coupled to a control unit;
means for receiving the control signal at the local access device and relaying the control signal to the control unit; and
means for actuating, in response to receiving the control signal at the control unit, the moveable structure from a first position to a second position.

13. The system as recited in claim 12, further comprising means for providing a cellular device caller options from a voice menu to command the moveable structure.

14. The system as recited in claim 12, further comprising:
means for utilizing Automatic Number Identification at the server to capture a telephone number associated with the cellular device; and
means for identifying the moveable structure based on the captured telephone number.

15. A method for wirelessly actuating a moveable structure, the method comprising:
accepting a command signal at a telephone disposed in wireless communication with a Publically Switched Telephone Network;
transmitting the accepted command signal over the Publically Switched Telephone Network;
verifying the command signal at a server;
upon verification of the command signal, transmitting a control signal over a cellular network to a local access device electromechanically coupled to a control unit;
receiving the control signal at the local access device and relaying the control signal to the control unit; and
in response to receiving the control signal at the control unit, actuating the moveable structure from a first position to a second position.

16. The method as recited in claim 15, further comprising providing a telephone caller options from a voice menu to command the moveable structure.

17. The method as recited in claim 15, further comprising:
utilizing Automatic Number Identification at the server to capture a telephone number associated with the telephone; and
identifying the moveable structure based on the captured telephone number.

18. A system for wirelessly actuating a moveable structure, the system comprising:
means for accepting a command signal at a telephone disposed in communication with a Publically Switched Telephone Network;
means for transmitting the accepted command signal over the Publically Switched Telephone Network;
means for verifying the command signal at a server;
means for transmitting, in response to verification of the command signal, a control signal over a cellular network to a local access device electromechanically coupled to a control unit;
means for receiving the control signal at the local access device and relaying the control signal to the control unit; and
means for actuating, in response to receiving the control signal at the control unit, the moveable structure from a first position to a second position.

19. The system as recited in claim 18, further comprising means for providing a telephone caller options from a voice menu to command the moveable structure.

20. The system as recited in claim 18, further comprising:
utilizing Automatic Number Identification at the server to capture a telephone number associated with the telephone; and
identifying the moveable structure based on the captured telephone number.

21. A system for wirelessly actuating a moveable structure, the system comprising:
a call box for placing a call;
a server disposed in wireless communication with the call box via a cellular network, the server for relaying audio communication between the call box and a telephone via the cellular network and a Publically Switched Telephone Network, respectively, and, in response to a command signal generated at the telephone, for generating a control signal;
a control unit associated with the moveable structure, the control unit for actuating the moveable structure from a first position to a second position in response to receiving the command signal; and
a local access device electromechanically coupled to the control unit and disposed in wireless communication with the server via the cellular network, the local access device for receiving the control signal from the server via the cellular network and forwarding the control signal to the control unit.

22. The system as recited in claim 21, wherein the moveable structure comprises a structure including one panel which completes a motion in order to at least partially close an entrance selected, the motion selected from the group consisting of being swung, being drawn, being raised, and being lowered.

23. The system as recited in claim 21, the server comprises an Interactive Voice Response (IVR) system which provides a cellular device caller options from a voice menu to command the moveable structure.

24. The system as recited in claim 21, wherein the control unit and the local access device are at least partially integrated.

25. A method for wirelessly actuating a moveable structure, the method comprising:
accepting an access code at a call box;
transmitting the access code over the cellular network;
receiving the access code at a server;
establishing a relay between the call box and a telephone via the cellular network and a Publically Switched Telephone Network, respectively;
upon receipt of a command signal from the telephone, transmitting a control signal over the cellular network to a local access device electromechanically coupled to a control unit;
receiving the control signal at the local access device and relaying the control signal to the control unit; and
in response to receiving the control signal at the control unit, actuating the moveable structure from a first position to a second position.

26. The method as recited in claim 25, further comprising:
utilizing the access code received at the server to identify the telephone to call; and
identifying the moveable structure based on the captured access code.

27. A system for wirelessly actuating a moveable structure, the system comprising:
means for accepting an access code at a call box;
means for transmitting the access code over the cellular network;
means for receiving the access code at a server;
means for establishing a relay between the call box and a telephone via the cellular network and a Publically Switched Telephone Network, respectively;
means, responsive to a command signal from the telephone, for transmitting a control signal over the cellular network to a local access device electromechanically coupled to a control unit;
means for receiving the control signal at the local access device and relaying the control signal to the control unit; and
means, responsive to receiving the control signal at the control unit, for actuating the moveable structure from a first position to a second position.

28. The system as recited in claim 27, further comprising:
means for utilizing the access code received at the server to identify the telephone to call; and
means for identifying the moveable structure based on the captured access code.

29. A system for wirelessly effecting a transition state change in a locking mechanism, the system comprising:
a cellular device disposed in wireless communication with a cellular network, the cellular device for accepting a command signal and transmitting the accepted command signal over the cellular network;
a server, in response to receiving the command signal, for verifying the command signal and, upon verification, transmitting a control signal over the cellular network;
a control unit associated with the locking mechanism, the control unit for effecting a transition in the locking mechanism from a first state to a second state in response to receiving a command signal; and
a local access device electromechanically coupled to the control unit and disposed in wireless communication with the cellular network, the local access device for receiving the control signal from the server and forwarding the control signal to the control unit.

30. The system as recited in claim 29, wherein the locking mechanism is selected from the groups consisting of mechanical devices, electromechanical devices, magnetic locks, and solenoid bolts.
